(19) United States
(12) Patent Application Publication
(10) Pub. No.: US 2026/0285311 A1
(43) Pub. Date: Sep. 24, 2026

(54) VEHICLE CONTROL APPARATUS, VEHICLE CONTROL METHOD, AND NON-TRANSITORY COMPUTER-READABLE STORAGE MEDIUM

(71) Applicants: TOYOTA JIDOSHA KABUSHIKI KAISHA, Toyota-shi (JP); DENSO CORPORATION, Kariya-city (JP)

(72) Inventors: Hideki KAMATANI, Toyota-shi (JP); Hiroki TERASHITA, Susono-shi (JP); Hirotada OTAKE, Susono-shi (JP)

(73) Assignees: TOYOTA JIDOSHA KABUSHIKI KAISHA, Toyota-shi (JP); DENSO CORPORATION, Kariya-city (JP)

(21) Appl. No.: 19/574,822

(22) Filed: Mar. 23, 2026

(30) Foreign Application Priority Data
Mar. 24, 2025 (JP) 2025-048572

(51) Int. Cl. B60W 30/16

(52) U.S. Cl. CPC B60W 30/16; B60W 2520/10; B60W 2552/15; B60W 2554/4041; B60W 2554/802; B60W 2720/106; B60W 2754/30

(57) ABSTRACT

A vehicle control apparatus configured to perform a driving assistance control including a first driving assistance control for controlling the acceleration based on a first vehicle speed range including a set vehicle speed, or a first inter-vehicle distance range including a set inter-vehicle distance and a second driving assistance control for controlling the acceleration based on a second vehicle speed range set wider than the first vehicle speed range, or a second inter-vehicle distance range set wider than the first inter-vehicle distance range. The vehicle control apparatus performs the first driving assistance control when the second driving assistance control is not requested. In a case where the second driving assistance control is requested, the vehicle control apparatus performs the second driving assistance control when the vehicle is not in the towing state, and suppresses the second driving assistance control when the vehicle is in the towing state.

### TECHNICAL FIELD

The present disclosure relates to a vehicle control apparatus configured to perform a driving assistance control for automatically driving a vehicle by controlling an acceleration of the vehicle, a vehicle control method for causing a computer mounted on the vehicle to perform the driving assistance control, and a non-transitory computer-readable storage medium storing a program for causing the computer to perform the driving assistance control.

### BACKGROUND

Conventionally, a vehicle control apparatus configured to perform a driving assistance control are known. For example, a vehicle control apparatus described in Patent Document 1 (hereinafter referred to as the “conventional apparatus”) is capable of performing a normal constant speed control and an eco constant speed control.

In the normal constant speed control, the conventional apparatus controls an acceleration of a vehicle so as to maintain a vehicle speed at a set speed. Specifically, the conventional apparatus accelerates the vehicle when the vehicle speed falls below the set speed, and the conventional apparatus decelerates the vehicle when the vehicle speed exceeds the set speed.

In the eco constant speed control, the conventional apparatus accelerates the vehicle when the vehicle speed falls below a lower limit value of a “vehicle speed range including the set speed” and decelerates the vehicle when the vehicle speed exceeds an upper limit value of the vehicle speed range. In the eco constant speed control, the conventional apparatus accelerates the vehicle such that an energy efficiency of a vehicle drive system is equal to or higher than a predetermined efficiency. Furthermore, in the eco constant speed control, the conventional apparatus decelerates the vehicle by coasting. The deceleration in the eco constant speed control may alternatively be performed by rotating a motor of the drive system using the vehicle’s kinetic energy to regenerate electric power. The eco constant speed control achieves higher energy efficiency than the normal constant speed control.

When a driver requests the normal constant speed control and does not request the eco constant speed control, the conventional apparatus performs the normal constant speed control. On the other hand, when the driver requests both the normal constant speed control and the eco constant speed control, the conventional apparatus performs the eco constant speed control.

Patent Document 1: Japanese Patent Application Laid-Open No. 2022-095320

### SUMMARY

When the vehicle tows a towed vehicle (such as a trailer or another vehicle), a controlled weight which is controlled by the drive system and the braking system of the vehicle is the total weight of the vehicle and the towed vehicle. The controlled weight when the vehicle tows the towed vehicle is greater than when the vehicle does not tow the towed vehicle. When the above-described eco constant speed control is performed while the vehicle is towing the towed vehicle, the energy efficiency is more likely to deteriorate compared with when the normal constant speed control is performed. Moreover, there is an increased possibility that the vehicle’s behavior during acceleration and deceleration will become less smooth, resulting in a deterioration of ride comfort for occupants.

The present disclosure has been made in order to address the above-described problems. That is, one of the objects of the present disclosure is to provide a vehicle control apparatus capable of reducing the possibility of deterioration in the energy efficiency and also reducing the possibility of deterioration in the ride comfort when the vehicle is towing the towed vehicle.

A vehicle control apparatus cording to the present disclosure (hereinafter, referred to as "the present apparatus") is configured to perform a driving assistance control for automatically driving a vehicle by controlling acceleration of the vehicle.

The driving assistance control includes:
a first driving assistance control for controlling the acceleration based on a first vehicle speed range including a set vehicle speed, or a first inter-vehicle distance range including a set inter-vehicle distance, such that the vehicle speed of the vehicle is maintained at the set vehicle speed or an inter-vehicle distance between a preceding vehicle in front of the vehicle and the vehicle is maintained at the set inter-vehicle distance (step 515, step 600 to step 695); and
a second driving assistance control for controlling the acceleration based on a second vehicle speed range including the set vehicle speed and set wider than the first vehicle speed range, or a second inter-vehicle distance range including the set inter-vehicle distance and set wider than the first inter-vehicle distance range (step 525, step 700 to step 795).

The vehicle control apparatus is configured to:
perform the first driving assistance control (step 515) in response to the second driving assistance control not being requested ("No" at step 510);
determine whether or not the vehicle is in a towing state representing that the vehicle is towing a towed vehicle (step 520) in response to the second driving assistance control being requested ("Yes" at step 510);
perform the second driving assistance control (step 525) in response to the vehicle not being in the towing state ("No" at step 520); and
suppress the second driving assistance control (step 515) in response to the vehicle being in the towing state ("Yes" at step 520).

According to the present apparatus, in response to the vehicle being in the towing state, the second driving assistance control is suppressed. As a result, it is possible to reduce the possibility of deterioration in energy efficiency while also reducing the possibility of deterioration in ride comfort for the occupants.

In one aspect of the present apparatus, the present apparatus is configured to suppress the second driving assistance control by performing the first driving assistance control without performing the second driving assistance control (step 515) in response to the vehicle being in the towing state ("Yes" at step 520).

According to this aspect, since the first driving assistance control is performed in response to the vehicle being in the towing state, it is possible to reduce the possibility of deterioration in the energy efficiency while also reducing the possibility of deterioration in the ride comfort for the occupants.

In one aspect of the present apparatus, the vehicle control apparatus is configured to:
in the first driving assistance control:
   perform a first acceleration control for accelerating the vehicle (step 625) in response to the vehicle speed becoming smaller than a lower limit value of the first vehicle speed range ("Yes" at step 620) or in response to the inter-vehicle distance becoming longer than an upper limit value of the first inter-vehicle distance range ("Yes" at step 640);
   perform a first deceleration control for decelerating the vehicle (step 635) in response to the vehicle speed becoming greater than an upper limit value of the first vehicle speed range ("Yes" at step 630) or in response to the inter-vehicle distance becoming shorter than a lower limit value of the first inter-vehicle distance range ("Yes" at step 645),
in the second driving assistance control:
   perform a second acceleration control for accelerating the vehicle (step 710) in response to the vehicle speed becoming smaller than a lower limit value of the second vehicle speed range ("Yes" at step 705) or in response to the inter-vehicle distance becoming longer than an upper limit value of the second inter-vehicle distance range ("Yes" at step 725);
   perform a second deceleration control for decelerating the vehicle with a deceleration smaller than that of the first deceleration control (step 720) in response to the vehicle speed becoming greater than an upper limit value of the second vehicle speed range ("Yes" at step 715) or in response to the inter-vehicle distance becoming shorter than a lower limit value of the second inter-vehicle distance range ("Yes" at step 730); and
in response to the second driving assistance control being requested and the vehicle being in the towing state ("Yes" at step 805),
   suppress the second driving assistance control by performing the first deceleration control instead of the second deceleration control (step 815).

The heavier the controlled weight, the greater the energy required to decelerate a controlled object having then controlled weight. Therefore, if the vehicle is decelerated by the second deceleration control when the vehicle is in the towing state, it takes more time until the vehicle speed becomes equal to or less than the upper limit value of the second vehicle speed range or until the inter-vehicle distance becomes equal to or greater than the lower limit value of the second inter-vehicle distance range. If a state in which the vehicle speed is greater than the upper limit value of the second vehicle speed range or a state in which the inter-vehicle distance is shorter than the lower limit value of the second inter-vehicle distance range continues, the occupants may feel uneasy. Therefore, according to this aspect, when the vehicle is in the towing state, the first deceleration control is performed instead of the second deceleration control. As a result, a duration of the above-described state can be shortened, and the possibility of causing uneasiness to the occupants can be reduced.

In one aspect of the present apparatus, the vehicle control apparatus is configured to suppress the second driving assistance control by performing a third driving assistance control for controlling the acceleration of the vehicle based on a third vehicle speed range including the set vehicle speed, set wider than the first vehicle speed range and narrower than the second vehicle speed range, or a third inter-vehicle distance range including the set inter-vehicle distance, set wider than the first inter-vehicle distance range and narrower than the second inter-vehicle distance range, in response to the vehicle being in the towing state.

As the vehicle speed range or the inter-vehicle distance range becomes wider, the energy efficiency increases but the ride comfort deteriorates. In this aspect, when the vehicle is in the towing state, the third driving assistance control is performed. In the third driving assistance control, the acceleration is controlled based on a third vehicle speed range that is set wider than the first vehicle speed range and narrower than the second vehicle speed range, or a third inter-vehicle distance range that is set wider than the first inter-vehicle distance range and narrower than the second inter-vehicle distance range. As a result, when the vehicle is in the towing state, it is possible to increase the possibility of achieving higher energy efficiency than in the case where the first driving assistance control is performed, and to improve ride comfort compared to the case where the second driving assistance control is performed.

In one aspect of the present apparatus, the present apparatus is configured to:
determine whether or not a predetermined execution condition is satisfied (step 530) in response to the vehicle being in the towing state;
suppress the second driving assistance control (step 515) in response to the execution condition not being satisfied ("No" at step 530); and
perform the second driving assistance control (step 525) in response to the execution condition being satisfied ("Yes" at step 530).

In the above aspect, the present apparatus is configured to determine that the execution condition is satisfied in response to the vehicle speed being equal to or lower than a threshold vehicle speed and a gradient of a lane in which the vehicle is traveling is equal to or smaller than a threshold gradient.

When the second driving assistance control is performed in a case where the vehicle speed is greater than the threshold vehicle speed, since a time required for the vehicle to decelerate becomes longer, the occupants are likely to feel a sense of discomfort. When the second driving assistance control is performed in a case where the gradient of the lane is greater than the threshold gradient, since a time required for the vehicle to accelerate becomes longer, the occupants are likely to feel a sense of discomfort. In these cases, since the execution condition is not satisfied, the first driving assistance control is performed, whereby the possibility that the occupants feel a sense of discomfort can be reduced.

A vehicle control method according to the present disclosure causes a computer mounted on a vehicle to perform a driving assistance control for automatically driving the vehicle by controlling acceleration of the vehicle.

The driving assistance control includes:
a first driving assistance control for controlling the acceleration based on a first vehicle speed range including a set vehicle speed, or a first inter-vehicle distance range including a set inter-vehicle distance, such that the vehicle speed of the vehicle is maintained at the set vehicle speed or an inter-vehicle distance between a preceding vehicle in front of the vehicle and the vehicle is maintained at the set inter-vehicle distance (step 515, step 600 to step 695); and
a second driving assistance control for controlling the acceleration based on a second vehicle speed range including the set vehicle speed and set wider than the first vehicle speed range, or a second inter-vehicle distance range including the set inter-vehicle distance and set wider than the first inter-vehicle distance range (step 525, step 700 to step 795).

The vehicle control method comprises:
a step of performing the first driving assistance control (step 515) in response to the second driving assistance control not being requested ("No" at step 510);
a step of determining whether or not the vehicle is in a towing state representing that the vehicle is towing a towed vehicle (step 520) in response to the second driving assistance control being requested ("Yes" at step 510);
a step of performing the second driving assistance control (step 525) in response to the vehicle not being in the towing state ("No" at step 520); and
a step of suppressing the second driving assistance control (step 515) in response to the vehicle being in the towing state ("Yes" at step 520).

A non-transitory computer-readable storage medium storing a program according to the present disclosure causes a computer mounted on a vehicle to perform a driving assistance control for automatically driving the vehicle by controlling acceleration of the vehicle.

The driving assistance control includes:
a first driving assistance control for controlling the acceleration based on a first vehicle speed range including a set vehicle speed, or a first inter-vehicle distance range including a set inter-vehicle distance, such that the vehicle speed of the vehicle is maintained at the set vehicle speed or an inter-vehicle distance between a preceding vehicle in front of the vehicle and the vehicle is maintained at the set inter-vehicle distance (step 515, step 600 to step 695); and
a second driving assistance control for controlling the acceleration based on a second vehicle speed range including the set vehicle speed and set wider than the first vehicle speed range, or a second inter-vehicle distance range including the set inter-vehicle distance and set wider than the first inter-vehicle distance range (step 525, step 700 to step 795).

The program causes the computer to:
perform the first driving assistance control (step 515) in response to the second driving assistance control not being requested ("No" at step 510)
determine whether or not the vehicle is in a towing state representing that the vehicle is towing a towed vehicle (step 520) in response to the second driving assistance control being requested ("Yes" at step 510);
perform the second driving assistance control (step 525) in response to the vehicle not being in the towing state ("No" at step 520); and
suppress the second driving assistance control (step 515) in response to the vehicle being in the towing state ("Yes" at step 520).

According to the above-described vehicle control method and the above-described program, when the vehicle is in the towing state, the second driving assistance control is suppressed. As a result, it is possible to reduce the possibility of deterioration in energy efficiency while also reducing the possibility of deterioration in ride comfort for the occupants.

### BRIEF DESCRIPTION OF THE DRAWINGS

FIG. 1 is a schematic system configuration diagram of a vehicle control apparatus according to an embodiment of the present disclosure.

FIG. 2 is an explanatory diagram of a normal constant speed control and an eco constant speed control.

FIG. 3 is an explanatory diagram of a relationship among an inter-vehicle distance, a set distance, and an upper limit value of a distance range.

FIG. 4 is a flowchart illustrating a towing determination routine executed by a CPU of an ECU shown in FIG. 1.

FIG. 5 is a flowchart illustrating a driving assistance control routine executed by the CPU of the ECU shown in FIG. 1.

FIG. 6 is a flowchart illustrating a normal driving assistance control subroutine executed by the CPU of the ECU shown in FIG. 1.

FIG. 7 is a flowchart illustrating an eco driving assistance control subroutine executed by the CPU of the ECU shown in FIG. 1.

FIG. 8 is a flowchart illustrating an eco driving assistance control subroutine according to a second modification of the embodiment of the present disclosure.

### DETAILED DESCRIPTION

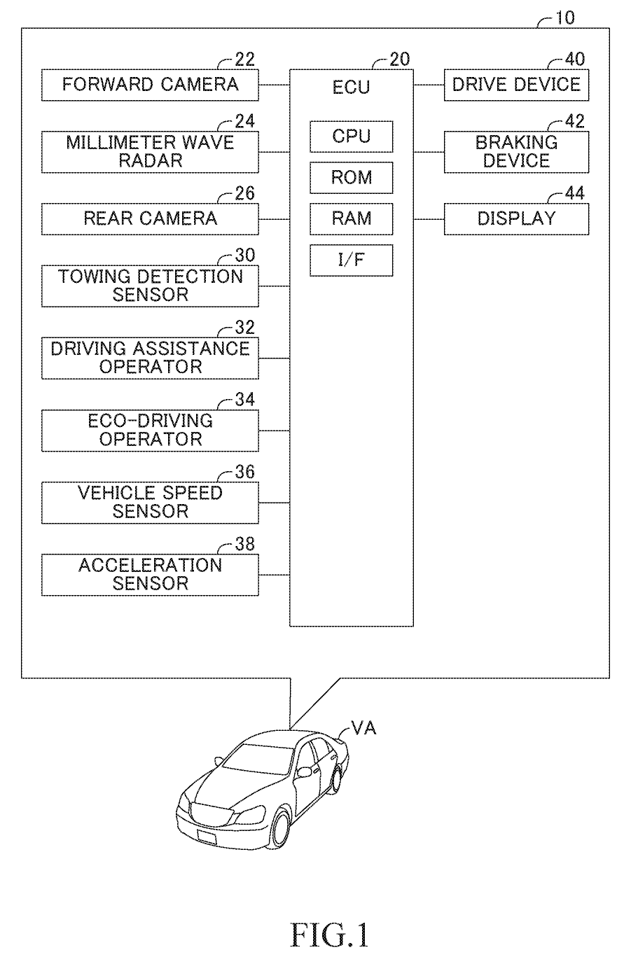

A vehicle control apparatus 10 according to an embodiment of the present disclosure (hereinafter referred to as “the present apparatus 10”) is applied to a vehicle VA and comprises an ECU 20 shown in FIG. 1. The ECU 20 is an electronic control unit comprising a microcomputer as its main component. The ECU 20 may also be referred to as a control unit, a controller, or a computer. The microcomputer includes a CPU (processor), ROM, RAM, and an interface (I/F), etc. Functions realized by the ECU 20 may alternatively be realized by a plurality of ECUs.

The ECU 20 is connected to a forward camera 22, a millimeter wave radar 24, a rear camera 26, a towing detection sensor 30, a driving assistance operator 32, an eco driving operator 34, a vehicle speed sensor 36, and an acceleration sensor 38.

The forward camera 22 acquires forward image data by capturing an image of an area in front of the vehicle VA. The millimeter wave radar 24 receives a reflected wave and acquires radar data. The reflected wave is a millimeter wave transmitted forward of the vehicle VA and reflected by an object. The radar data includes data relating to a position of the object relative to the vehicle VA and a relative speed Vr of the object with respect to the vehicle VA.

The ECU 20 acquires the forward image data from the forward camera 22 and the radar data from the millimeter wave radar 24. Based on the forward image data and the radar data, the ECU 20 recognizes the object in front of the vehicle VA.

The rear camera 26 acquires rear image data by capturing an image of an area behind the vehicle VA. The ECU 20 acquires the rear image data from the rear camera 26.

The towing detection sensor 30 is a sensor for detecting whether or not the vehicle VA is towing a towed vehicle. For example, the towing detection sensor 30 is disposed on a towing hook. As one example, when the vehicle VA is towing the towed vehicle, the towing detection sensor 30 outputs “1" as a detection value, and when the vehicle VA is not towing a towed vehicle, it outputs “0” as the detection value. The ECU 20 acquires the detection value from the towing detection sensor 30.

The driving assistance operator 32 is operated by the driver and comprises switches and buttons. The driving assistance operator 32 is disposed near a steering wheel of the vehicle VA. The driving assistance operator 32 comprises a driving assistance selection switch, a vehicle speed setting switch, a vehicle speed increase button, a vehicle speed decrease button, and an inter-vehicle distance setting button.

When the driving assistance selection switch is operated by the driver while a driving assistance control described later is not being performed, the driving assistance operator 32 transmits a signal to the ECU 20. Upon receiving the signal, the ECU 20 determines that the driver is requesting the driving assistance control. On the other hand, when the driving assistance selection switch is operated by the driver while the driving assistance control is being performed, the driving assistance operator 32 transmits a signal to the ECU 20. Upon receiving the signal, the ECU 20 determines that the driver is requesting termination of the driving assistance control.

When the vehicle speed setting switch is operated by the driver while the driving assistance control is being performed, the driving assistance operator 32 transmits a signal to the ECU 20. Upon receiving the signal, the ECU 20 sets a vehicle speed Vs of the vehicle VA at that time at which the ECU 20 receives the signal as the set vehicle speed Vset in the driving assistance control.

When the vehicle speed increase button is operated by the driver while the driving assistance control is being performed, the driving assistance operator 32 transmits a signal to the ECU 20. Upon receiving the signal, the ECU 20 increases the set vehicle speed Vset. On the other hand, when the vehicle speed decrease button is operated by the driver while the driving assistance control is being performed, the driving assistance operator 32 transmits a signal to the ECU 20. Upon receiving the signal, the ECU 20 decreases the set vehicle speed Vset.

When the inter-vehicle distance setting button is operated by the driver while the driving assistance control is being performed, the driving assistance operator 32 transmits a signal to the ECU 20. Upon receiving the signal, the ECU 20 changes a set distance Dset described later.

The eco driving operator 34 is operated by the driver. The eco driving operator 34 comprises switches and buttons. The eco driving operator 34 is disposed near the steering wheel of the vehicle VA. When the eco driving operator 34 positioned at an OFF position is operated, it becomes positioned at an ON position. When the eco driving operator 34 becomes positioned at the ON position, it transmits a signal to the ECU 20. Upon receiving the signal, the ECU 20 determines that the driver is requesting an eco driving control described later.

When the eco driving operator 34 becomes positioned at the OFF position, it transmits a signal to the ECU 20. Upon receiving the signal, the ECU 20 determines that the driver is not requesting the eco driving control.

The vehicle speed sensor 36 measures the vehicle speed Vs. The acceleration sensor 38 measures an acceleration G of the vehicle VA. The ECU 20 acquires the measurement values from the vehicle speed sensor 36 and the acceleration sensor 38.

A drive device 40 outputs a driving force for traveling the vehicle VA. For example, the drive device 40 is an internal combustion engine and/or a motor. The ECU 20 controls the driving force output from the drive device 40 by controlling an operation of the drive device 40. A braking device 42 is a device that outputs a braking force for braking the vehicle VA. The ECU 20 controls the braking force output from the braking device 42 by controlling the operation of the braking device 42. A display 44 is disposed at a position visible to the driver. In this example, the display 44 is a touch-panel display.

### Driving Assistance Control

When the driving assistance control is requested, the ECU 20 performs the driving assistance control. The driving assistance control includes a normal driving assistance control and an eco driving assistance control. The normal driving assistance control includes a normal constant speed control and a normal following control. The eco driving assistance control includes an eco constant speed control and an eco following control. The eco driving assistance control achieves higher energy efficiency than the normal driving assistance control. When the driver desires to improve the fuel efficiency of the vehicle VA, the driver requests the eco driving assistance control. The normal driving assistance control may be referred to as “a first driving assistance control,” and the eco driving assistance control may be referred to as “a second driving assistance control.”

### Normal Driving Assistance Control

When the driving assistance control is requested and the eco driving assistance control is not requested, the ECU 20 performs the normal driving assistance control. Specifically, the ECU 20 determines whether or not there is a preceding vehicle VB (see FIG. 3). When there is no preceding vehicle VB, the ECU 20 performs the normal constant speed control as the normal driving assistance control. When there is the preceding vehicle VB, the ECU 20 performs the normal following control as the normal driving assistance control.

The ECU 20 specifies another vehicle that satisfies the following conditions S1 and S2 as the preceding vehicle VB.

Condition S1: The other vehicle travels in the same lane as the vehicle VA and is present ahead of the vehicle VA.

Condition S2: An inter-vehicle distance D (see FIG. 3) between the vehicle VA and the other vehicle is equal to or less than a threshold distance.

### Normal Constant Speed Control

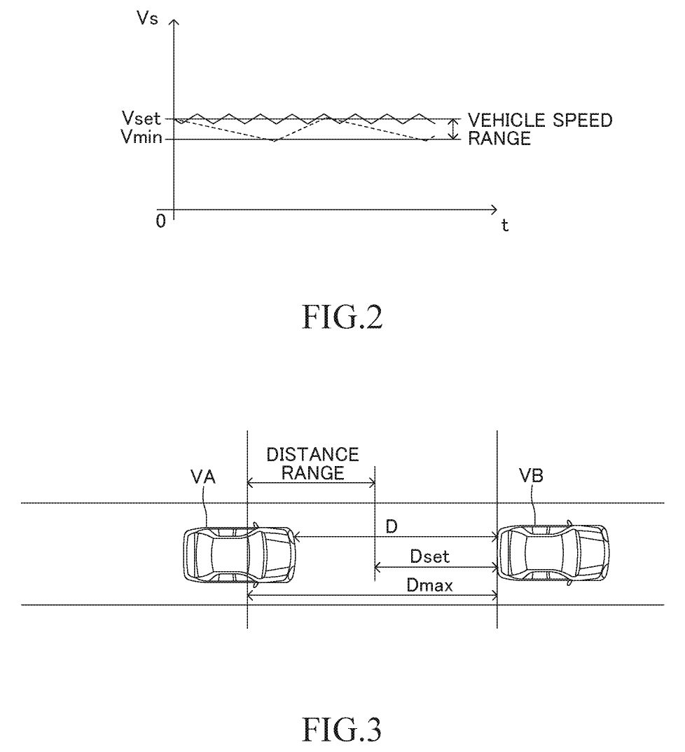

In the normal constant speed control, the ECU 20 accelerates or decelerates the vehicle VA (i.e., controls the acceleration G of the vehicle VA) such that the vehicle speed Vs is maintained at the set vehicle speed Vset. As shown by a solid line in FIG. 2, when the vehicle speed Vs falls below the set vehicle speed Vset, the ECU 20 accelerates the vehicle VA, and when the vehicle speed Vs exceeds the set vehicle speed Vset, the ECU 20 decelerates the vehicle VA. More specifically, the ECU 20 acquires a required acceleration Greq such that a convergence speed of the vehicle speed Vs to the set vehicle speed Vset is equal to or greater than a predetermined speed. The ECU 20 acquires a required braking force or a required driving force to achieve the required acceleration Greq. The ECU 20 controls the drive device 40 and/or the braking device 42 such that the required braking force or the required driving force is output.

### Normal Following Control

In the normal following control, the ECU 20 accelerates or decelerates the vehicle VA (i.e., controls the acceleration of the vehicle VA) such that the inter-vehicle distance D shown in FIG. 3 is maintained at the set distance Dset. When the inter-vehicle distance D becomes longer than the set distance Dset, the ECU 20 accelerates the vehicle VA, and when the inter-vehicle distance D becomes shorter than the set distance Dset, the ECU 20 decelerates the vehicle VA. More specifically, the ECU 20 obtains the required acceleration Greq such that a convergence speed of the inter-vehicle distance D to the set distance Dset is equal to or greater than a predetermined speed. The ECU 20 acquires the required braking force or the required driving force to achieve the required acceleration Greq. The ECU 20 controls the drive device 40 and/or the braking device 42 such that the required braking force or the required driving force is output.

In the normal constant speed control and the normal following control, a control in which the ECU 20 controls the drive device 40 and/or the braking device 42 such that the required driving force to achieve the required acceleration Greq is output is referred to as “a normal acceleration control” or “a first acceleration control.” A control in which the ECU 20 controls the drive device 40 and/or the braking device 42 such that the required braking force to achieve the required acceleration Greq is output is referred to as “a normal deceleration control” or “a first deceleration control.”

### Eco Driving Assistance Control

When the driving assistance control is requested and the eco driving assistance control is also requested, the ECU 20 performs the eco driving assistance control. Specifically, when there is no preceding vehicle VB, the ECU 20 performs the eco constant speed control as the eco driving assistance control, and when there is the preceding vehicle VB, the ECU 20 performs the eco following control as the eco driving assistance control.

### Eco Constant Speed Control

In the eco constant speed control, the ECU 20 accelerates or decelerates the vehicle VA (i.e., controls the acceleration of the vehicle VA) such that the vehicle speed Vs is maintained within a “vehicle speed range in which the set vehicle speed Vset is set as an upper limit value Vmax”. As shown by a dotted line in FIG. 2, when the vehicle speed Vs falls below a lower limit value Vmin of the vehicle speed range, the ECU 20 accelerates the vehicle VA, and when the vehicle speed Vs exceeds the upper limit value Vmax (the set vehicle speed Vset) of the vehicle speed range, the ECU 20 decelerates the vehicle VA.

In a case where the ECU 20 accelerates the vehicle VA in the eco constant speed control, the ECU 20, based on the vehicle speed Vs, acquires, as the required acceleration Greq, an acceleration G at which the energy efficiency of the drive device 40 during output of driving force is equal to or greater than a predetermined efficiency. The ECU 20 controls the drive device 40 and/or the braking device 42 such that the required driving force to achieve the required acceleration Greq is output.

In a case where the ECU 20 decelerates the vehicle VA in the eco constant speed control, the ECU 20 acquires, as the required acceleration Greq, an acceleration G at which the required driving force becomes zero. Thus, when the vehicle VA decelerates in the eco constant speed control, the vehicle VA coasts. Hereinafter, such a deceleration is referred to as “a coasting deceleration.”

When the drive device 40 includes the motor, the ECU 20 may decelerate the vehicle VA in the eco constant speed control by rotating the motor with a traveling energy of the vehicle VA to regenerate electric power. Hereinafter, such a deceleration is referred to as “a regenerative deceleration.”

### Eco Following Control

In the eco following control, the ECU 20 determines a distance range (see FIG. 3) used for determining whether the vehicle VA accelerates or decelerates. In this example, a lower limit value Dmin of the distance range is set to the set distance Dset. When the inter-vehicle distance D becomes longer than an upper limit value Dmax of the distance range, the ECU 20 accelerates the vehicle VA, and when the inter-vehicle distance D becomes shorter than the lower limit value Dmin (the set distance Dset) of the distance range, the ECU 20 decelerates the vehicle VA. It should be noted that acceleration and deceleration of the vehicle VA in the eco following control are performed in the same manner as the acceleration and deceleration of the vehicle VA in the eco constant speed control.

The control of accelerating the vehicle VA in the eco constant speed control and the eco following control is referred to as “an eco acceleration control” or “a second acceleration control,” and the control of decelerating the vehicle VA in the eco constant speed control and the eco following control is referred to as “an eco deceleration control” or “a second deceleration control.” In the eco acceleration control, the vehicle VA accelerates with a smaller acceleration than in the normal acceleration control, and in the eco deceleration control, the vehicle VA decelerates with a smaller deceleration than in the normal deceleration control.

### Outline of Operation

When the driving assistance control is requested and the eco driving assistance control is also requested, the ECU 20 determines whether or not the vehicle VA is in a towing state in which the vehicle VA tows a towed vehicle (such as a trailer or another vehicle). When the vehicle VA is not in the towing state, the ECU 20 performs the eco driving assistance control.

On the other hand, when the vehicle VA is in the towing state, the ECU 20 suppresses the eco driving assistance control. Specifically, when the vehicle VA is in the towing state, the ECU 20 suppresses the eco driving assistance control by executing the normal driving assistance control instead of executing the eco driving assistance control.

When the vehicle VA is in the towing state, the controlled weight controlled by the drive device 40 and the braking device 42 is heavier than when the vehicle VA is not in the towing state. If the eco driving assistance control is performed under such a condition, the possibility of deterioration in energy efficiency increases, and the possibility of deterioration in ride comfort also increases. In this example, when the vehicle VA is in the towing state, the normal driving assistance control is performed instead of performing the eco driving assistance control. As a result, it is possible to reduce the possibility of deterioration in the energy efficiency and also reduce the possibility of deterioration in the ride comfort when the vehicle VA is in the towing state.

### Specific Operation

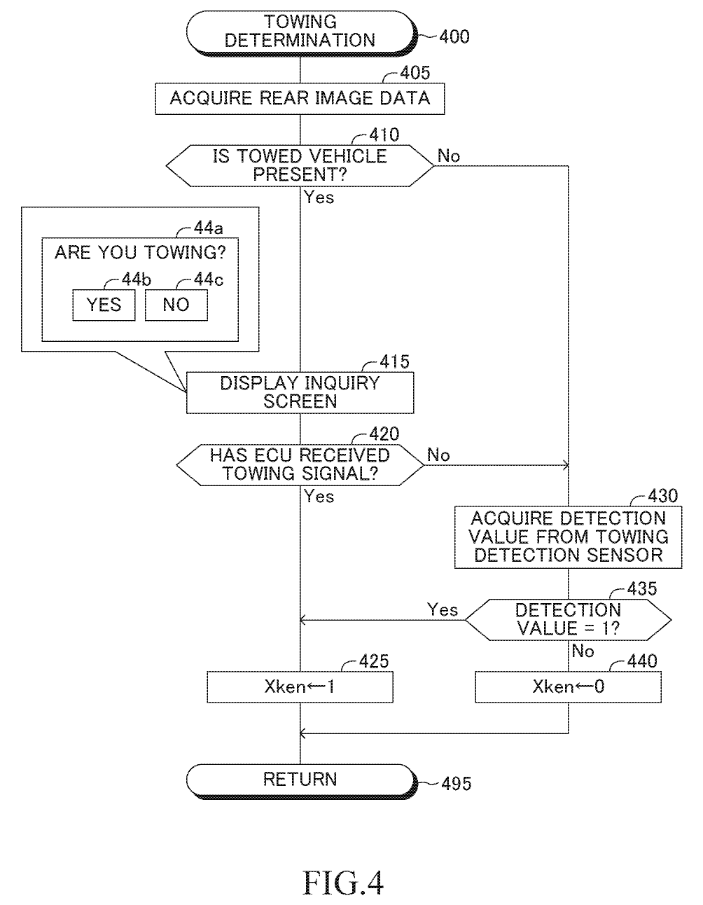

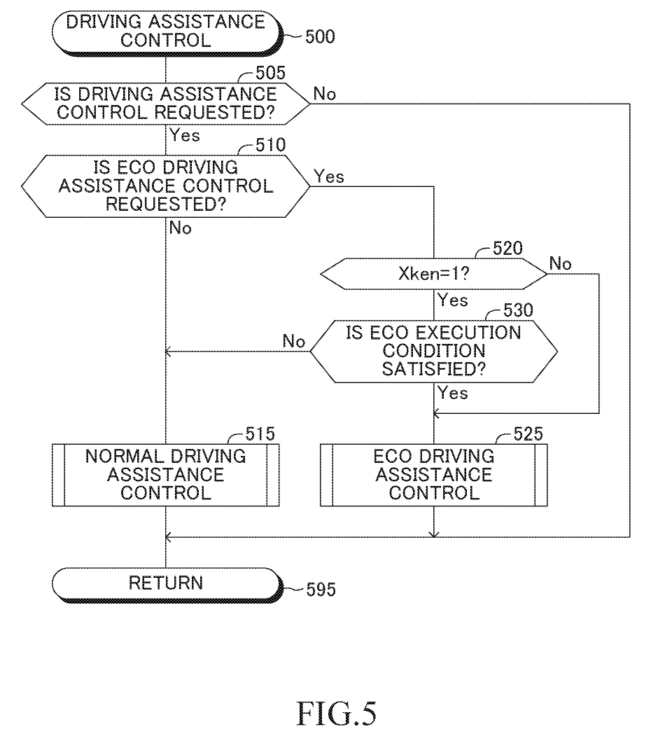

The CPU of the ECU 20 executes routines shown in the flowcharts of FIGS. 4 and 5 each time a predetermined time period elapses.

### Towing Determination Routine

When an appropriate timing comes, the CPU starts a process from step 400 in FIG. 4 and executes step 405 and step 410.

Step 405: The CPU acquires the rear image data from the rear camera 26.

Step 410: The CPU determines whether or not the towed vehicle is present behind the vehicle VA based on the rear image data.

When the towed vehicle is present, the CPU makes a “Yes” determination at step 410 and executes step 415 and step 420.

Step 415: The CPU displays an inquiry screen 44a on the display 44.

The inquiry screen 44a displays a message “Are you towing?”, a YES button 44b, and a NO button 44c.

When the vehicle VA is towing the towed vehicle, the driver touches the YES button 44b. When the YES button 44b is touched, the display 44 transmits a towing signal to the ECU 20. On the other hand, when the vehicle VA is not towing a towed vehicle, the driver touches the NO button 44c. When the NO button 44c is touched, the display 44 transmits a non-towing signal to the ECU 20.

Step 420: The CPU determines whether or not the ECU 20 has received the towing signal.

When the ECU 20 has received the towing signal, the CPU makes a “Yes” determination at step 420 and the process proceeds to step 425. At step 425, the CPU sets a towing flag Xken to “1.”

The towing flag Xken is set to “1” when the vehicle VA is in the towing state, and is set to “0” when the vehicle VA is not in the towing state. The towing flag Xken is set to “0” in an initialization routine. The initialization routine is executed by the CPU when an ignition key switch (not shown) of the vehicle VA is switched from an OFF position to an ON position.

After the CPU executes step 425, the process proceeds to step 495. At step 495, the CPU temporarily ends this routine.

When no towed vehicle is present at step 410, the CPU makes a “No” determination at step 410 and executes step 430 and step 435.

Step 430: The CPU acquires the detection value from the towing detection sensor 30.

Step 435: The CPU determines whether or not the detection value is “1.”

When the detection value is “1” (i.e., the vehicle VA is towing the towed vehicle), the CPU makes a “Yes” determination at step 435, and sets the towing flag Xken to “1” at step 425. Thereafter, the process proceeds to step 495.

On the other hand, when the detection value is “0” (i.e., the vehicle VA is not towing the towed vehicle), the CPU makes a “No” determination at step 435, and the process proceeds to step 440. The CPU sets the towing flag Xken to “0” at step 440. Thereafter, the process proceeds to step 495.

When the ECU 20 has received the non-towing signal at step 420, or when a predetermined time has elapsed after the inquiry screen 44a is displayed without the ECU 20 receiving either the towing signal or the non-towing signal, the CPU makes a “No” determination at step 420 and the process proceeds to step 430.

When any one of the following cases occurs, the CPU determines whether or not the vehicle VA is in the towing state based on the detection value of the towing detection sensor 30.

Case 1: Although the vehicle VA is in the towing state, it is determined for some reason based on the rear image data that no towed vehicle is present (step 410: “No”).

Case 2: Although the vehicle VA is in the towing state, the driver erroneously operates the NO button 44c (step 420: “No”).

Case 3: Although the vehicle VA is in the towing state, the driver does not operate either the YES button 44b or the NO button 44c (step 420: “No”).

Thus, whether or not the vehicle VA is in the towing state can be determined more accurately.

### Driving Assistance Control Routine

When an appropriate timing comes, the CPU starts a process from step 500 in FIG. 5, and the process proceeds to step 505. At step 505, the CPU determines whether or not the driving assistance control is requested.

When the driving assistance control is not requested, the CPU makes a “No” determination at step 505, the process proceeds to step 595. The CPU temporarily ends this routine at step 595.

When the driving assistance control is requested, the CPU makes a “Yes” determination at step 505, and the process proceeds to step 510. At step 510, The CPU determines whether or not the eco driving assistance control is requested.

When the eco driving assistance control is not requested, the CPU makes a “No” determination at step 510, and the process proceeds to step 515. At step 515, the CPU executes a normal driving assistance control subroutine for performing the normal driving assistance control. Details of the normal driving assistance control subroutine will be described later. Thereafter, the process proceeds to step 595.

On the other hand, when the eco driving assistance control is requested, the CPU makes a “Yes” determination at step 510, the process proceeds to step 520. At step 520, the CPU determines whether or not the towing flag Xken is “1.”

When the towing flag Xken is “0,” the CPU makes a “No” determination at step 520, and the process proceeds to step 525. At step 525, the CPU executes an eco driving assistance control subroutine for performing the eco driving assistance control. Details of the eco driving assistance control subroutine will be described later. Thereafter, the process proceeds to step 595.

On the other hand, when the towing flag Xken is “1,” the CPU makes a “Yes” determination at step 520, and the process proceeds to step 530. At step 530, the CPU determines whether or not an eco execution conditions is satisfied. The CPU determines that the eco execution condition is satisfied when both of the following conditions E1 and E2 are satisfied.

Condition E1: The vehicle speed Vs is equal to or less than a threshold vehicle speed Vsth.

Condition E2: A road gradient θ of a lane in which the vehicle VA is traveling is equal to or less than a threshold gradient θth set to a positive value.

The gradient θ is positive when the vehicle VA is ascending a slope and negative when the vehicle VA is descending a slope. The CPU specifies the gradient θ based on the acceleration G measured by the acceleration sensor 38. Alternatively, the CPU may refer to map data in which road gradients θ are registered and specify the gradient θ at the current position of the vehicle VA specified based on GNSS (Global Navigation Satellite System).

When the eco execution condition is not satisfied, the CPU makes a “No” determination at step 530, and the process proceeds to step 515. At step 515, the CPU performs the normal driving assistance control. On the other hand, when the eco execution condition is satisfied, the CPU makes a “Yes” determination at step 530, and the process proceeds to step 525. At step 525, the CPU performs the eco driving assistance control.

When the vehicle VA is in the towing state, the controlled weight is heavy. If the eco deceleration control is performed when the vehicle VA is in the towing state and the vehicle speed Vs is greater than the threshold vehicle speed Vsth, it is highly likely that it will take time until the vehicle VA decelerates. As a result, the occupants are likely to feel discomfort. If the eco acceleration control is performed while the vehicle VA is ascending the slope having the gradient θ greater than the threshold gradient θth, it is highly likely that it will take time until the vehicle VA accelerates. As a result, the occupants are likely to feel discomfort. In this example, since the normal driving assistance control is performed when the eco execution condition is not satisfied, it is possible to reduce the possibility that the driver feels discomfort.

### Normal Driving Assistance Control Subroutine

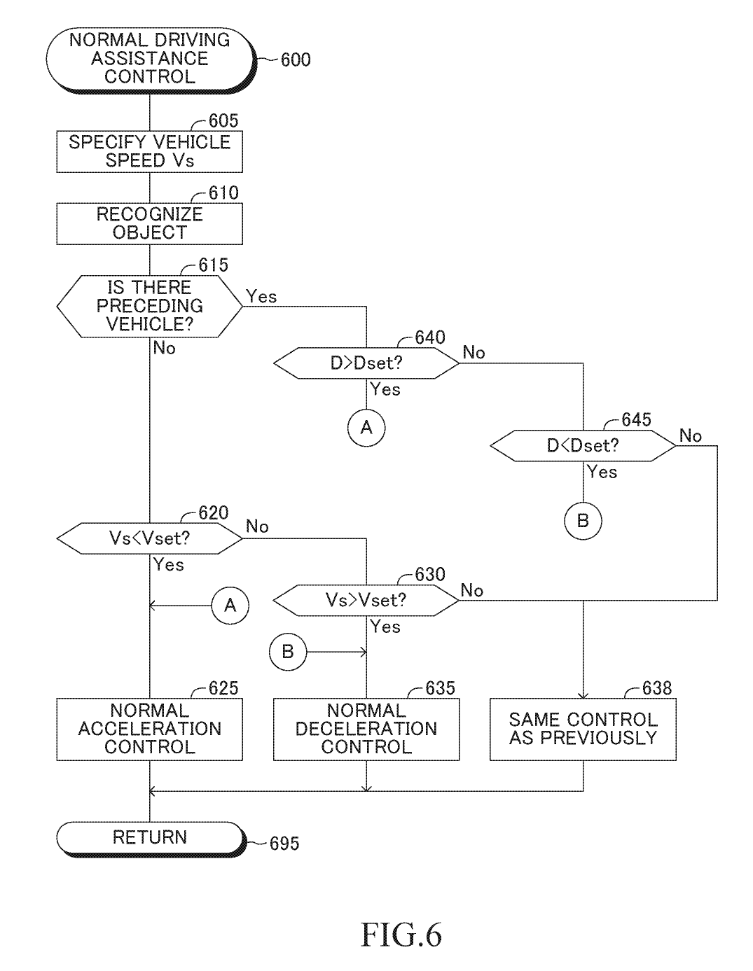

When the process proceeds to step 515, the CPU starts a process from step 600 shown in FIG. 6 and executes step 605 to step 615.

Step 605: The CPU acquires the measurement value from the vehicle speed sensor 36 and specifies the vehicle speed Vs.

Step 610: The CPU recognizes the object in front of the vehicle VA based on the forward image data and the radar data.

Step 615: The CPU determines whether or not there is the preceding vehicle VB.

When there is no preceding vehicle VB, the CPU performs the normal constant speed control. Specifically, when there is no preceding vehicle VB, the CPU makes a “No” determination at step 615, and the process proceeds to step 620. At step 620, the CPU determines whether or not the vehicle speed Vs is smaller than the set vehicle speed Vset.

When the vehicle speed Vs is smaller than the set vehicle speed Vset, the CPU makes a “Yes” determination at step 620, and the process proceeds to step 625 At step 625, the CPU performs the normal acceleration control for accelerating the vehicle VA in the normal driving assistance control. Thereafter, the process proceeds to step 695, and the CPU temporarily ends this routine. Thereafter, the process proceeds to step 595 shown in FIG. 5.

When the vehicle speed Vs is equal to or greater than the set vehicle speed Vset, the CPU makes a “No” determination at step 620, and the process proceeds to step 630. At step 630, the CPU determines whether or not the vehicle speed Vs is greater than the set vehicle speed Vset.

When the vehicle speed Vs is greater than the set vehicle speed Vset, the CPU makes a “Yes” determination at step 630, and the process proceeds to step 635. At step 635, the CPU performs the normal deceleration control for decelerating the vehicle VA in the normal driving assistance control. Thereafter, the process proceeds to step 695.

On the other hand, when the vehicle speed Vs is not greater than the set vehicle speed Vset (i.e., when the vehicle speed Vs is equal to the set vehicle speed Vset), the CPU makes a “No” determination at step 630, the process proceeds to step 638. At step 638, the CPU performs the same control as that performed when this routine was executed previously. Specifically, when the normal acceleration control was performed previously, the CPU performs the normal acceleration control, and when the normal deceleration control was performed previously, the CPU performs the normal deceleration control. Thereafter, the process proceeds to step 695.

In a case where there is the preceding vehicle VB when the process proceeds to step 615, the CPU performs the normal following control. Specifically, when there is the preceding vehicle VB, the CPU makes a “Yes” determination at step 615 and the process proceeds to step 640.

At step 640, the CPU determines whether or not the inter-vehicle distance D between the vehicle VA and the preceding vehicle VB is longer than the set distance Dset. When the inter-vehicle distance D is longer than the set distance Dset, the CPU makes a “Yes” determination at step 640 and performs the normal acceleration control at step 625.

On the other hand, when the inter-vehicle distance D is equal to or shorter than the set distance Dset, the CPU makes a “No” determination at step 640, and the process proceeds to step 645. At step 645, the CPU determines whether or not the inter-vehicle distance D is shorter than the set distance Dset.

When the inter-vehicle distance D is shorter than the set distance Dset, the CPU makes a “Yes” determination at step 645 and performs the normal deceleration control at step 635.

On the other hand, when the inter-vehicle distance D is equal to the set distance Dset, the CPU makes a “No” determination at step 645 and the process proceeds to step 638.

### Eco Driving Assistance Control Subroutine

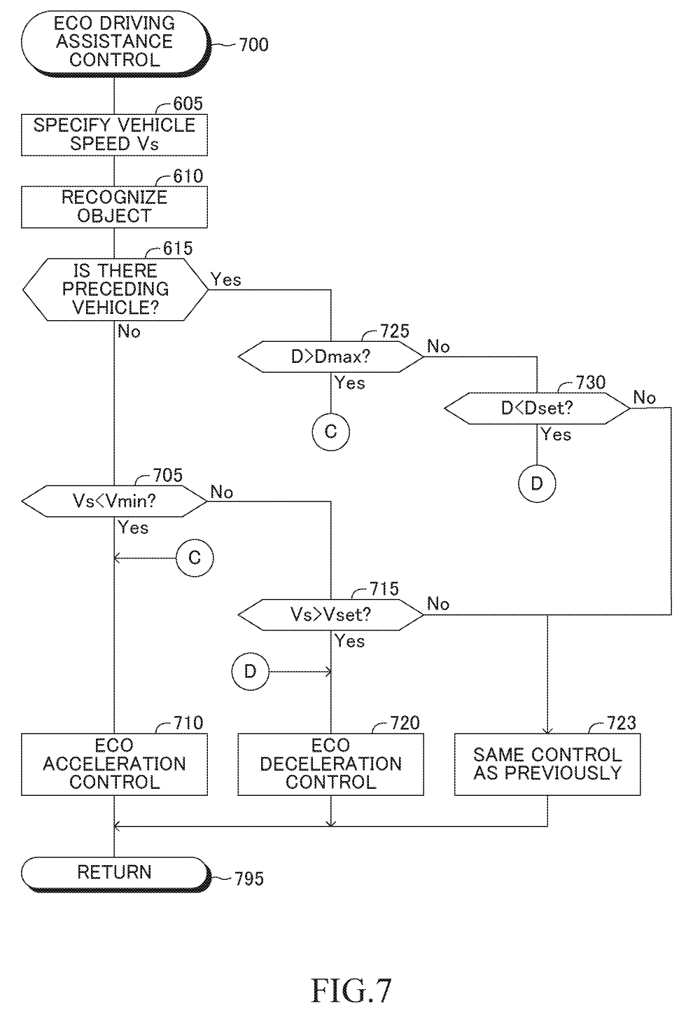

When the process proceeds to step 525, the CPU starts a process from step 700 shown in FIG. 7. In FIG. 7, steps that are the same as those shown in FIG. 6 are given the same reference numerals as those in FIG. 6, and their description is omitted.

The CPU executes step 605 to step 615 shown in FIG. 7. When there is no preceding vehicle VB, the CPU performs the eco constant speed control. Specifically, when there is no preceding vehicle VB, the CPU makes a “No” determination at step 615 shown in FIG. 7, and the process proceeds to step 705. At step 705, the CPU determines whether or not the vehicle speed Vs is smaller than the lower limit value Vmin of the vehicle speed range.

When the vehicle speed Vs is smaller than the lower limit value Vmin of the vehicle speed range, the CPU makes a “Yes” determination at step 705, and the process proceeds to step 710. At step 710, the CPU performs the eco acceleration control. Thereafter, the process proceeds to step 795, and the CPU temporarily ends this routine. Thereafter, the process proceeds to step 595 shown in FIG. 5.

When the vehicle speed Vs is equal to or greater than the lower limit value Vmin of the vehicle speed range, the CPU makes a “No” determination at step 705, and the process proceeds to step 715. At step 715, the CPU determines whether or not the vehicle speed Vs is greater than the set vehicle speed Vset, which is the upper limit value Vmax of the vehicle speed range.

When the vehicle speed Vs is greater than the set vehicle speed Vset, the CPU makes a “Yes” determination at step 715, and the process proceeds to step 720. At step 720, the CPU performs the eco deceleration control. Thereafter, the process proceeds to step 795.

When the vehicle speed Vs is equal to or greater than the lower limit value Vmin of the vehicle speed range and equal to or less than the set vehicle speed Vset, the CPU makes a “No” determination at step 715, and the process proceeds to step 723. At step 723, the CPU performs the same control as that performed when this routine was executed previously. Specifically, when the eco acceleration control was performed previously, the CPU performs the eco acceleration control, and when the eco deceleration control was performed previously, the CPU performs the eco deceleration control. Thereafter, the process proceeds to step 795.

In a case where there is the preceding vehicle VB when the process proceeds to step 615 shown in FIG. 7, the CPU performs the eco following control. Specifically, when there is the preceding vehicle VB, the CPU makes a “Yes” determination at step 615 shown in FIG. 7 and the process proceeds to step 725.

At step 725, the CPU determines whether or not the inter-vehicle distance D is longer than the upper limit value Dmax of the distance range. When the inter-vehicle distance D is longer than the upper limit value Dmax, the CPU makes a “Yes” determination at step 725 and performs the eco acceleration control at step 710.

On the other hand, when the inter-vehicle distance D is equal to or shorter than the upper limit value Dmax of the distance range, the CPU makes a “No” determination at step 725, and the process proceeds to step 730. At step 730, the CPU determines whether or not the inter-vehicle distance D is shorter than the set distance Dset, which is the lower limit value of the distance range.

When the inter-vehicle distance D is shorter than the set distance Dset, the CPU makes a “Yes” determination at step 730 and performs the eco deceleration control at step 720.

On the other hand, when the inter-vehicle distance D is equal to or shorter than the upper limit value Dmax of the distance range and equal to or greater than the set distance Dset, the CPU makes a “No” determination at step 730 and the process proceeds to step 723.

As described above, according to this example, when the driving assistance control is requested and the eco driving assistance control is also requested while the vehicle VA is in the towing state, the eco driving assistance control is suppressed. Accordingly, when the vehicle VA is in the towing state, it is possible to reduce the possibility of deterioration in energy efficiency and reduce the possibility of deterioration in ride comfort.

The present disclosure is not limited to the embodiments described above, and various modifications of the present disclosure can be adopted.

### First Modification

In the normal constant speed control of this modification, when the vehicle speed Vs falls below the lower limit value of the vehicle speed range, the ECU 20 performs the normal acceleration control, and when the vehicle speed Vs exceeds the upper limit value of the vehicle speed range, the ECU 20 performs the normal deceleration control. The vehicle speed range for the normal constant speed control may be referred to as “a first vehicle speed range,” and the vehicle speed range for the eco constant speed control may be referred to as “a second vehicle speed range.” The upper limit value of the first vehicle speed range is set to the set vehicle speed Vset. The second vehicle speed range is set to be wider than the first vehicle speed range.

In the normal following control of this modification, when the inter-vehicle distance D exceeds the upper limit value of the distance range, the normal acceleration control is performed, and when the inter-vehicle distance D falls below the lower limit value of the distance range, which is the set distance Dset, the normal deceleration control is performed. The distance range for the normal following control may be referred to as “a first distance range,” and the distance range for the eco following control may be referred to as “a second distance range.” The lower limit value of the first distance range is set to the set distance Dset. The second distance range is set to be wider than the first distance range.

### Second Modification

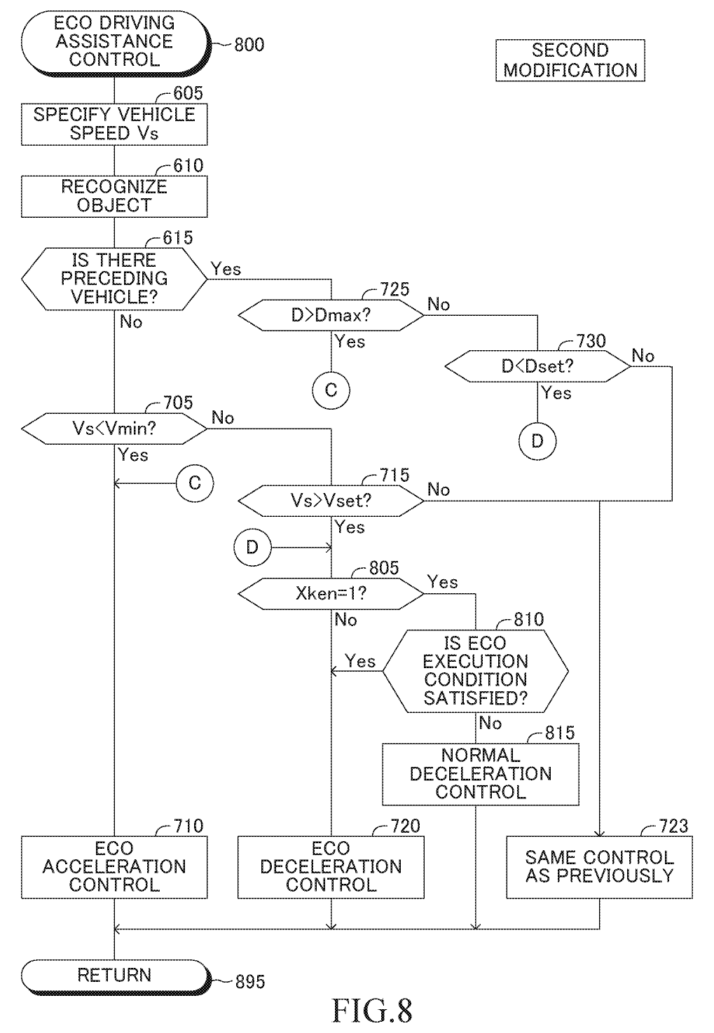

In this modification, when the eco driving assistance control is requested ("Yes" at step 510 shown in FIG. 5), the process proceeds to step 525 shown in FIG. 5, and the CPU executes an eco driving assistance control subroutine shown in FIG. 8 (i.e., the CPU starts a process from step 800 shown in FIG. 8). In FIG. 8, steps that are the same as those shown in FIGS. 6 and 7 are given the same reference numerals as those in FIGS. 6 and 7, and their description is omitted.

When the vehicle speed Vs is greater than the set vehicle speed Vset, which is the upper limit value of the vehicle speed range ("Yes" at step 715 shown in FIG. 8), or when the inter-vehicle distance D is smaller than the set distance Dset, which is the lower limit value of the distance range ("Yes" at step 730 shown in FIG. 8), the process proceeds to step 805.

At step 805, the CPU determines whether or not the towing flag Xken is "1." When the towing flag Xken is "0," the CPU makes a "No" determination at step 805, and the process proceeds to step 720 shown in FIG. 8. On the other hand, when the towing flag Xken is "1," the CPU makes a "Yes" determination at step 805, and the process proceeds to step 810.

At step 810, the CPU determines whether or not the eco execution condition is satisfied. When the eco execution condition is satisfied, the CPU makes a "Yes" determination at step 810, and the process proceeds to step 720 shown in FIG. 8. On the other hand, when the eco execution condition is not satisfied, the CPU makes a "No" determination at step 810, and the process proceeds to step 815. At step 815, the CPU performs the normal deceleration control. Thereafter, the process proceeds to step 895, and the CPU temporarily terminates this routine.

Accordingly, when the driving assistance control is requested and the eco driving assistance control is also requested, if the vehicle VA is in the towing state and the eco execution condition is not satisfied, the normal deceleration control is performed instead of the eco deceleration control. This suppresses the eco driving assistance control. Therefore, when the vehicle VA is in the towing state and the eco execution condition is not satisfied, it is sufficient that at least eco deceleration control is suppressed.

By performing the normal deceleration control instead of the eco deceleration control, the time until the vehicle speed Vs becomes equal to or less than the set vehicle speed Vset, or until the inter-vehicle distance D becomes equal to or greater than the set distance Dset, can be shortened. This makes it possible to reduce the possibility of causing anxiety to the occupants.

### Third Modification

In this modification, in a case where the vehicle VA is in the towing state and the eco execution condition is not satisfied when the driving assistance control is requested and the eco driving assistance control is also requested, the CPU performs a suppressed eco driving assistance control (a third driving assistance control). In the suppressed eco driving assistance control, when there is no preceding vehicle VB, the CPU performs a suppressed eco constant speed control, and when there is the preceding vehicle VB, the CPU performs a suppressed eco following control.

In the suppressed eco constant speed control, the CPU controls acceleration and deceleration of the vehicle VA based on a “third vehicle speed range whose upper limit value is set to the set vehicle speed Vset, and which is wider than the first vehicle speed range and narrower than the second vehicle speed range.” Specifically, when the vehicle speed Vs falls below the lower limit value of the third vehicle speed range, the CPU performs the eco acceleration control, and when the vehicle speed Vs exceeds the upper limit value of the third vehicle speed range, the CPU performs the eco deceleration control.

In the suppressed eco following control, the CPU controls acceleration and deceleration of the vehicle VA based on a “third distance range whose lower limit value is set to the set distance Dset, and which is wider than the first distance range and narrower than the second distance range.” Specifically, when the inter-vehicle distance D exceeds the upper limit value of the third distance range, the CPU performs eco acceleration control, and when the inter-vehicle distance D falls below the set distance Dset, which is the lower limit value of the third distance range, the CPU performs the eco deceleration control.

As the vehicle speed range or the distance range becomes wider, the energy efficiency increases but the ride comfort deteriorates. In this modification, the suppressed eco driving assistance control is performed when the vehicle VA is in the towing state and the eco execution condition is not satisfied. Accordingly, when the vehicle is in the towing state, it is possible to achieve higher energy efficiency than in the case where the normal driving assistance control is performed, and better ride comfort than in the case where the eco driving assistance control is performed.

### Fourth Modification

In the driving assistance control routine shown in FIG. 5, the determination as to whether the eco execution condition is satisfied (step 530) may be omitted. Similarly, in the eco driving assistance control subroutine shown in FIG. 8, the determination as to whether the eco execution condition is satisfied (step 810) may be omitted.

### Fifth Modification

In the normal following control, the eco following control, and the suppressed eco following control, instead of the inter-vehicle distance D, an arrival time T until the vehicle VA reaches the preceding vehicle VB may be used.

### Sixth Modification

In the above embodiment, the upper limit value Vmax of the vehicle speed range in the eco constant speed control is set to the set vehicle speed Vset, but it is sufficient that the vehicle speed range includes the set vehicle speed Vset. The lower limit value Dmin of the distance range in the eco following control is set to the set distance Dset, but it is sufficient that the distance range includes the set distance Dset.

### Seventh Modification

The eco deceleration control is not limited to coasting deceleration and regenerative deceleration. As long as the control provides a deceleration smaller than that of the normal deceleration control, it can be regarded as the eco deceleration control.

### Eighth Modification

The present apparatus 10 does not need to comprise both the forward camera 22 and the millimeter wave radar 24. It is sufficient that the present apparatus 10 comprises at least one device capable of detecting an object. Furthermore, the present apparatus 10 may comprise a rear radar and/or rear sonar capable of detecting an object behind the vehicle VA. The present apparatus 10 may determine whether or not the towed object is present based on the detection result of the rear radar and/or rear sonar.

The present apparatus 10 can be applied to (or installed in/on) an engine vehicle, a hybrid electric vehicle (HEV), a plug-in hybrid electric vehicle (PHEV), a fuel cell electric vehicle (FCEV), and a battery electric vehicle (BEV). Furthermore, the present apparatus 10 can also be applied to an autonomous driving vehicle. The present disclosure can be understood as a non-transitory computer-readable storage medium in which a program for realizing the functions of the present apparatus 10 is stored.

What is claimed is:

1. A vehicle control apparatus configured to perform a driving assistance control for automatically driving a vehicle by controlling acceleration of the vehicle,
wherein the driving assistance control includes:
a first driving assistance control for controlling the acceleration based on a first vehicle speed range including a set vehicle speed, or a first inter-vehicle distance range including a set inter-vehicle distance, such that the vehicle speed of the vehicle is maintained at the set vehicle speed or an inter-vehicle distance between a preceding vehicle in front of the vehicle and the vehicle is maintained at the set inter-vehicle distance; and
a second driving assistance control for controlling the acceleration based on a second vehicle speed range including the set vehicle speed and set wider than the first vehicle speed range, or a second inter-vehicle distance range including the set inter-vehicle distance and set wider than the first inter-vehicle distance range,
wherein the vehicle control apparatus is configured to:
perform the first driving assistance control in response to the second driving assistance control not being requested;
determine whether or not the vehicle is in a towing state representing that the vehicle is towing a towed vehicle in response to the second driving assistance control being requested;
perform the second driving assistance control in response to the vehicle not being in the towing state; and
suppress the second driving assistance control in response to the vehicle being in the towing state.

2. The vehicle control apparatus according to claim 1,
wherein the vehicle control apparatus is configured to suppress the second driving assistance control by performing the first driving assistance control without performing the second driving assistance control in response to the vehicle being in the towing state.

3. The vehicle control apparatus according to claim 1,
wherein the vehicle control apparatus is configured to:
in the first driving assistance control:
perform a first acceleration control for accelerating the vehicle in response to the vehicle speed becoming smaller than a lower limit value of the first vehicle speed range or in response to the inter-vehicle distance becoming longer than an upper limit value of the first inter-vehicle distance range;
perform a first deceleration control for decelerating the vehicle in response to the vehicle speed becoming greater than an upper limit value of the first vehicle speed range or in response to the inter-vehicle distance becoming shorter than a lower limit value of the first inter-vehicle distance range,
in the second driving assistance control:
perform a second acceleration control for accelerating the vehicle in response to the vehicle speed becoming smaller than a lower limit value of the second vehicle speed range or in response to the inter-vehicle distance becoming longer than an upper limit value of the second inter-vehicle distance range;
perform a second deceleration control for decelerating the vehicle with a magnitude of deceleration smaller than that of the first deceleration control in response to the vehicle speed becoming greater than an upper limit value of the second vehicle speed range or in response to the inter-vehicle distance becoming shorter than a lower limit value of the second inter-vehicle distance range; and
in response to the second driving assistance control being requested and the vehicle being in the towing state,
suppress the second driving assistance control by performing the first deceleration control instead of the second deceleration control.

4. The vehicle control apparatus according to claim 1,
wherein the vehicle control apparatus is configured to suppress the second driving assistance control by performing a third driving assistance control for controlling the acceleration of the vehicle based on a third vehicle speed range including the set vehicle speed, set wider than the first vehicle speed range and narrower than the second vehicle speed range, or a third inter-vehicle distance range including the set inter-vehicle distance, set wider than the first inter-vehicle distance range and narrower than the second inter-vehicle distance range, in response to the vehicle being in the towing state.

5. The vehicle control apparatus according to claim 1,
wherein the vehicle control apparatus is configured to:
determine whether or not a predetermined execution condition is satisfied in response to the vehicle being in the towing state;
suppress the second driving assistance control in response to the execution condition not being satisfied; and
perform the second driving assistance control in response to the execution condition being satisfied.

6. The vehicle control apparatus according to claim 5,
wherein the vehicle control apparatus is configured to determine that the execution condition is satisfied in response to the vehicle speed being equal to or lower than a threshold vehicle speed and a gradient of a lane in which the vehicle is traveling is equal to or smaller than a threshold gradient.

7. A vehicle control method for causing a computer mounted on a vehicle to perform a driving assistance control for automatically driving the vehicle by controlling acceleration of the vehicle,
wherein the driving assistance control includes:
a first driving assistance control for controlling the acceleration based on a first vehicle speed range including a set vehicle speed, or a first inter-vehicle distance range including a set inter-vehicle distance, such that the vehicle speed of the vehicle is maintained at the set vehicle speed or an inter-vehicle distance between a preceding vehicle in front of the vehicle and the vehicle is maintained at the set inter-vehicle distance; and
a second driving assistance control for controlling the acceleration based on a second vehicle speed range including the set vehicle speed and set wider than the first vehicle speed range, or a second inter-vehicle distance range including the set inter-vehicle distance and set wider than the first inter-vehicle distance range,
wherein the vehicle control method comprises:
a step of performing the first driving assistance control in response to the second driving assistance control not being requested;
a step of determining whether or not the vehicle is in a towing state representing that the vehicle is towing a towed vehicle in response to the second driving assistance control being requested;
a step of performing the second driving assistance control in response to the vehicle not being in the towing state; and
a step of suppressing the second driving assistance control in response to the vehicle being in the towing state.

8. A non-transitory computer-readable storage medium storing a program for causing a computer mounted on a vehicle to perform a driving assistance control for automatically driving the vehicle by controlling acceleration of the vehicle,
wherein the driving assistance control includes:
a first driving assistance control for controlling the acceleration based on a first vehicle speed range including a set vehicle speed, or a first inter-vehicle distance range including a set inter-vehicle distance, such that the vehicle speed of the vehicle is maintained at the set vehicle speed or an inter-vehicle distance between a preceding vehicle in front of the vehicle and the vehicle is maintained at the set inter-vehicle distance; and
a second driving assistance control for controlling the acceleration based on a second vehicle speed range including the set vehicle speed and set wider than the first vehicle speed range, or a second inter-vehicle distance range including the set inter-vehicle distance and set wider than the first inter-vehicle distance range,
wherein the program causes the computer to:
perform the first driving assistance control in response to the second driving assistance control not being requested;
determine whether or not the vehicle is in a towing state representing that the vehicle is towing a towed vehicle in response to the second driving assistance control being requested;
perform the second driving assistance control in response to the vehicle not being in the towing state; and
suppress the second driving assistance control in response to the vehicle being in the towing state.
